(19) United States
(12) Patent Application Publication
(10) Pub. No.: US 2013/0242533 A1
(43) Pub. Date: Sep. 19, 2013

(54) METHOD AND APPARATUS FOR A COLOR FILTER

(71) Applicants: Yi Li, Pleasanton, CA (US); Yi Yang, Shenzhen (CN); Liangliang Cao, Shenzhen (CN); Fei Hu, Shenzhen (CN)

(72) Inventors: Yi Li, Pleasanton, CA (US); Yi Yang, Shenzhen (CN); Liangliang Cao, Shenzhen (CN); Fei Hu, Shenzhen (CN)

(73) Assignee: Appotronics Corporation Limited, Guangdong (CN)

(21) Appl. No.: 13/611,730

(22) Filed: Sep. 12, 2012

Related U.S. Application Data
(60) Provisional application No. 61/533,395, filed on Sep. 12, 2011.

(51) Int. Cl. F21V 9/10

(52) U.S. Cl. CPC F21V 9/10
USPC 362/84

(57) ABSTRACT

A method and apparatus for a color filter that utilizes a wavelength conversion material such as phosphor to filter an input light. The input light contains unwanted shorter wavelength light and wanted longer wavelength light. The wavelength conversion material converts the light in the unwanted shorter wavelength range to the wanted longer wavelength range, and transmits the light in the wanted longer wavelength range, to generate an output light in the longer wavelength range. The filter may be a transmissive type of a reflective type. The filter may be constructed as a moving filter such as a rotating wheel.

This application claims priority under 35 USC §119(e) from U.S. Provisional Patent Application No. 61/533,395, filed Sep. 12, 2011, which is herein incorporated by reference in its entirety.

### BACKGROUND OF THE INVENTION

1. Field of the Invention

The present invention is in the technical field of color filters.

2. Description of the Related Art

Color filters are widely used in projection systems, stage lighting, photography and other optical applications. One type of color filter is an absorptive filter which absorbs unwanted wavelength of light and transmits others. The absorption of unwanted light will heat up the filter. Therefore absorptive filters have short lifetimes and cannot tolerate high intensity light. Another type of color filter is a dichroic filter which can reflect some wavelength of the light and transmit the remainder. As most of the light is reflected or transmitted rather than absorbed, dichroic filters do not become heated as the absorptive filters. Therefore dichroic filters have much longer lifetime and can withstand high intensity light. Dichroic filters are usually made of multilayer coatings built up on a glass substrate. According to the principle of thin-film interference, dichroic filters' transmittance spectrum depends on the incident angle of the input light. To illustrate this point, FIG. 1 shows an example of the transmittance spectrum of a particular red pass dichroic filter when the incident angle is 0, 30 and 60 degrees, respectively. The transmitted light will have very different spectra when the incident angle changes.

### SUMMARY OF THE INVENTION

The present invention is a method and apparatus for a color filter that can reject unwanted wavelength of light and accept wanted wavelength. The color filter utilizes one or more wavelength down conversion materials and therefore can provide intensity gain for the wanted wavelength.

Additional features and advantages of the invention will be set forth in the descriptions that follow and in part will be apparent from the description, or may be learned by practice of the invention. The objectives and other advantages of the invention will be realized and attained by the structure particularly pointed out in the written description and claims thereof as well as the appended drawings.

To achieve these and other advantages and in accordance with the purpose of the present invention, as embodied and broadly described, the present invention provides a light source system which includes: a light source for generating an input light containing light in a first wavelength range and light in a second wavelength range, the first wavelength range being shorter than the second wavelength range; and a color filter disposed to receive the input light and to generate an output light in the second wavelength range, the color filter including a substrate carrying a wavelength conversion material, the wavelength conversion material absorbing the input light in the first wavelength range and converting it to light in the second wavelength range, the wavelength conversion material further transmitting the input light in the second wavelength range.

In another aspect, the present invention provides a method for generating a light, which includes: generating an input light containing light in a first wavelength range and light in a second wavelength range, the first wavelength range being shorter than the second wavelength range; and illuminating the input light on a color filter, the color filter including a substrate carrying a wavelength conversion material which absorbs the input light in the first wavelength range and converts it to light in the second wavelength range and transmits the input light in the second wavelength range, to generate an output light in the second wavelength range.

It is to be understood that both the foregoing general description and the following detailed description are exemplary and explanatory and are intended to provide further explanation of the invention as claimed.

### BRIEF DESCRIPTION OF THE DRAWINGS

FIG. 1 shows the transmittance spectrum of a red pass dichroic filter when the incident angle of the input light is 0, 30 and 60 degrees, respectively.

FIG. 2 shows excitation and emission spectra of a red phosphor.

FIG. 3 shows an example of transmittance spectrum of a red phosphor used as a color filter according to an embodiment of the present invention.

FIG. 4 shows a color filter according to one embodiment of the present invention in which the color filter is composed of a transparent plate with a phosphor film coated on its surface.

FIG. 5 shows a color filter according to one embodiment of the present invention in which the phosphor is coated on a transparent rotary wheel.

FIG. 6 shows a color filter according to another embodiment of the present invention in which the color filter is composed of a reflective plate with a phosphor film coated on its surface and other collection optics.

FIG. 7 shows a color filter according to another embodiment of the present invention.

FIG. 8 shows a color filter according to a variation of the embodiment of the present invention shown in FIG. 7.

FIG. 9 shows a color filter according to another embodiment of the present invention combining the phosphor wheel and color filter shown in FIG. 7.

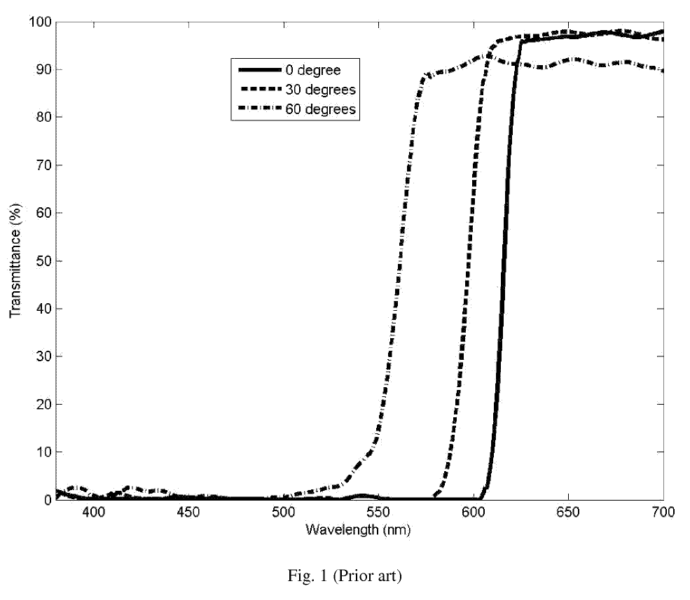

### DETAILED DESCRIPTION OF THE PREFERRED EMBODIMENTS

Embodiments of the present invention provide a method and apparatus for a color filter that utilizes wavelength down conversion materials such as phosphors to convert light in unwanted wavelength range to light in wanted wavelength range.

Phosphors will be used in the following description; however, the present invention covers all down conversion materials including phosphors and quantum dots, etc.

Phosphors are generally used to generate high brightness color light by absorbing an excitation light and emitting a converted light at a wavelength longer than that of the excitation light. Embodiments of the present invention exploit this characteristic of phosphors to filter light using a principle different from that of dichroic filters and conventional absorptive filters.

A red phosphor, i.e., a phosphor that emits a converted light in the red wavelength region, is used in the description below, but other phosphors may also be used.

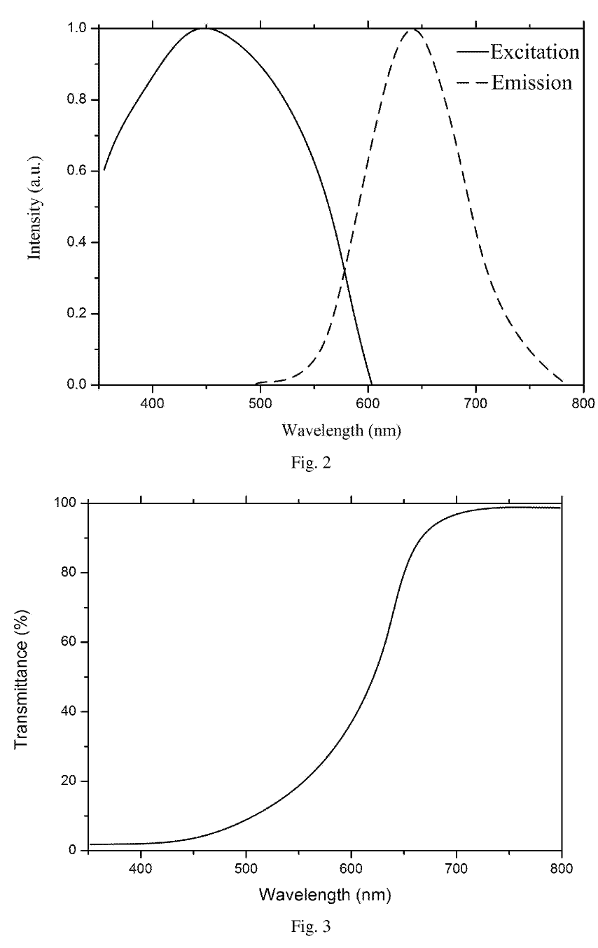

FIG. 2 shows examples of excitation and emission spectra of a red phosphor. This phosphor can absorb excitation light shown in FIG. 2 and generate light at longer wavelengths, e.g. from about 600 nm to 700 nm. In the example of FIG. 2, the excitation spectrum has a dominant wavelength at about 450 nm and the emission spectrum has a dominant wavelength at about 640. With this wavelength-selective absorption property, the red phosphor has a transmittance spectrum shown in FIG. 3. When an input light, for example, with wavelengths ranging from 380 to 780 nm, illuminates on this phosphor, the light at wavelengths shorter than 600 nm will be substantially absorbed, while the remaining light with wavelengths between 600 nm and 780 nm will be substantially transmitted. What's more, the red phosphor will re-emit red light with wavelengths between 600 nm and 780 nm from the absorbed light. Therefore the total red light output can be even stronger than the red portion of the original input light. Thus the red phosphor acts as a red filter that has a gain for red light energy, which makes it more efficient than the passive dichroic and conventional absorptive filters.

Compared with dichroic filters, an additional advantage of the color filter according to embodiments of the present invention is that the passband is independent of the incident angle of input light, since neither the absorption nor the emission of phosphors is sensitive to the incident angle. Compared with conventional absorptive color filters, heat generation is substantially reduced, and the output intensity in the desired wavelength range may be increased.

FIG. 4 shows a schematic view of a color filter according to one embodiment of the present invention. The color filter includes a transparent plate 401 with a phosphor film coated on its surface. As schematically illustrated, the light incident on the plate includes shorter wavelength light 402 and longer wavelength light 403. The phosphor absorbs the shorter wavelength light 402 and converts it to a longer wavelength light; it also passes the longer wavelength light 403. Thus only longer wavelength light is present at the downstream side of the plate, and its energy is increased. The input light may have various incident angles while the corresponding spectra of output light will remain substantially constant.

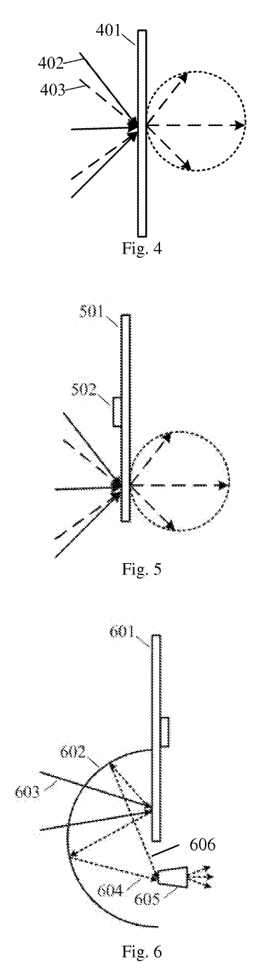

In another embodiment of the present invention, the phosphor substrate is a movable substrate, such as a rotating disc, a rotating drum or linear moving plate to improve heat dissipation. FIG. 5 shows a schematic view of a color filter according to one embodiment of the present invention in which the phosphor is coated on a transparent rotary wheel 501 which rotates around an axis 502. The moveable substrate moves relative to the input light, and allows different areas of the phosphor material to be illuminated by the input light at different times, thereby increasing heat dissipation capability of the color filter.

FIG. 6 shows a schematic view of a color filter according to another embodiment of the present invention. A phosphor film is coated on a substrate, such as a rotary wheel 601, which has a reflective surface. The reflective surface is farther away from the input light source than the phosphor material. In one example, a reflective coating is formed on the substrate surface facing away from the input light and the phosphor is formed on the substrate surface facing the input light. In another example, the reflective coating is formed on the substrate surface facing the input light and the phosphor is formed on the reflective coating. In yet another example, the reflective coating is formed on the substrate surface facing away from the input light and the phosphor is mixed in the substrate. The input light 603 illuminates on the wheel 601. Part of the input light, at shorter wavelengths, is absorbed by the phosphor, and part of the input light, at longer wavelengths, is not absorbed and is reflected by the reflective surface of the wheel 601. The absorbed shorter wavelength light will undergo a down conversion and some amount of light with longer wavelength will be re-emitted. The unabsorbed and reflected light 604 and the phosphor emission light 606 both have longer wavelengths, and are collected by a spherical or elliptical reflector 602 to collection optics 605. The forward traveling part of the phosphor emitted light is reflected by the reflective surface of the wheel 601 before being collected by the reflector 602.

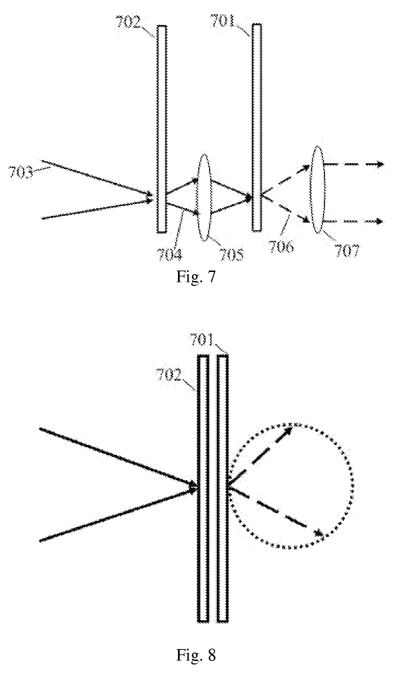

FIG. 7 shows a schematic view of a color filter system according to another embodiment of the present invention. This system employs two phosphors. A blue light 703 excites a yellow phosphor on a substrate 702 to generate a yellow light. The blue light 703 is not fully absorbed by the yellow phosphor; the unabsorbed blue light and the phosphor-generated yellow light combines to become a white light 704 since the yellow light covers both the green and red spectral ranges. The substrate 701 coated with a red phosphor is used as a color filter. Such a color filter allows red light to pass and absorbs light at wavelength shorter than red light. The white light 704 is directed by relay optics 705 to the substrate 701. The transmitted red light 706 on the downstream side of the color filter 701 includes both red light contained in the input white light 704 and red light generated by the red phosphor on the substrate 701. Consequently, the method and device can generate red light more efficiently than conventional absorptive color filters or dichroic filters. In this embodiment, the phosphor substrate 701 and 702 can also be movable.

FIG. 8 shows a variation of the embodiment of the present invention shown in FIG. 7. The difference is that the two phosphor substrates 702 and 701 are disposed in parallel at a sufficiently close proximity so that the relay optics 705 between them (see FIG. 7) is not needed. Alternatively, a red phosphor film and a yellow phosphor film can be formed on a same substrate, which can be either transmissive or reflective.

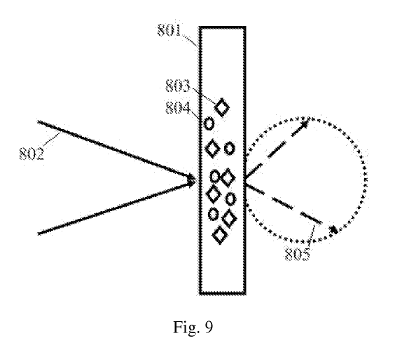

FIG. 9 shows a schematic view of a color filter according to another embodiment of the present invention. The phosphor plate 801 includes a mixture of different phosphors, for example, a yellow phosphor 803 and red phosphor 804. An excitation light 802 such as a blue light is used to excite the phosphor plate 801. The yellow phosphor 803 converts a part of the excitation light 802 to a yellow light, which covers both the green and red spectral range. The red phosphor 804 acts as a color filter, absorbing blue light and green light and emitting red light. The final output light 805 is a red light. The phosphor plate 801 can be movable. Similarly, phosphor plate 801 can be reflective type as well, in which case the yellow phosphor 803 and red phosphor 804 are formed a substrate that has a reflective surface.

The embodiments of FIGS. 7, 8 and 9, which use two phosphors, provide more flexibility for the type of lights that can be used as input to the color filter system.

In embodiments of the present invention, the phosphor material(s) may be either coated on the substrate or mixed in the substrate.

Although a red phosphor is used in the above description as an example, other wavelength conversion materials may be used. More generally, the wavelength conversion material absorbs an excitation light in a first (shorter) wavelength range and converts it to light in a second (longer) wavelength range, and substantially transmits light outside of the first wavelength range. In embodiments where two wavelength conversion materials are used, the second wavelength conversion material absorbs an excitation light in a third (shorter than the first) wavelength range and converts it to a light in the first (shorter) and second (longer) wavelength range, and (optionally) passes some of the light in the third wavelength range; the first wavelength conversion material absorbs the light in the third (if any) and first wavelength ranges and converts it to light in the second wavelength range, and passes light in the second wavelength range.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention as claimed.

What is claimed is:

1. A light source system comprising:
a light source for generating an input light containing light in a first wavelength range and light in a second wavelength range, the first wavelength range being shorter than the second wavelength range; and
a color filter disposed to receive the input light and to generate an output light in the second wavelength range, the color filter including a substrate carrying a wavelength conversion material, the wavelength conversion material absorbing the input light in the first wavelength range and converting it to light in the second wavelength range, the wavelength conversion material further transmitting the input light in the second wavelength range.

2. The light source system of claim 1, wherein the input light has a wavelength range of at least 380 to 780 nm, and wherein the first wavelength range is 380 to 600 nm and the second wavelength range is 600 to 780 nm.

3. The light source system of claim 1, wherein the color filter further includes a reflective coating formed on the substrate, wherein the reflective coating reflects the converted light in the second wavelength range generated by the wavelength conversion material, and reflects the input light in the second wavelength range transmitted by the wavelength conversion material.

4. The light source system of claim 3, further comprising:
collection optics; and
a reflector disposed to reflect light from the color filter to the collection optics.

5. The light source system of claim 1, wherein the substrate is moveable relative to the input light.

6. The light source system of claim 1, wherein the wavelength conversion material is coated on the substrate or mixed in the substrate.

7. The light source system of claim 1, wherein the light source comprises:
an excitation light source for generating an excitation light in a third wavelength range shorter than the first and second wavelength range; and
a wavelength conversion device including a second substrate carrying a second wavelength conversion material and disposed to receive the excitation light, wherein the second wavelength conversion material absorbs the excitation light and converts it to the input light containing light in the first wavelength range and light in the second wavelength range.

8. The light source system of claim 7, wherein the wavelength conversion device is disposed in parallel to the color filter in proximity of each other.

9. The light source system of claim 7, further comprising optics disposed between the color filter and the wavelength conversion device to focus the input light onto the color filter.

10. A method for generating a light, comprising:
generating an input light containing light in a first wavelength range and light in a second wavelength range, the first wavelength range being shorter than the second wavelength range; and
illuminating the input light on a color filter, the color filter including a substrate carrying a wavelength conversion material which absorbs the input light in the first wavelength range and converts it to light in the second wavelength range and transmits the input light in the second wavelength range, to generate an output light in the second wavelength range.

11. The method of claim 10, wherein the input light has a wavelength range of at least 380 to 780 nm, and wherein the first wavelength range is 380 to 600 nm and the second wavelength range is 600 to 780 nm.

12. The method of claim 10, further comprising moving the substrate relative to the input light to illuminate different portions of the wavelength conversion material.

13. The method of claim 10, wherein the step of generating an input light comprises:
generating an excitation light in a third wavelength range shorter than the first and second wavelength range; and
converting the excitation light to the input light containing light in the first wavelength range and light in the second wavelength range.
